(19) United States
(12) Patent Application Publication
(10) Pub. No.: US 2025/0244976 A1
(43) Pub. Date: Jul. 31, 2025

(54) UNROLLING AN INFINITE LOOP DURING RAY QUERY TRAVERSAL

(71) Applicant: QUALCOMM Incorporated, San Diego, CA (US)

(72) Inventors: Yash AGRAWAL, Varanasi (IN); Adarsh GOLIKERI, Bengaluru (IN); Ramachandra CHAKENALLI NANJEGOWDA, Bangalore (IN); Andrew Evan GRUBER, Arlington, MA (US)

(21) Appl. No.: 18/427,683

(22) Filed: Jan. 30, 2024

(51) Int. Cl. G06F 8/41; G06T 15/06; G06T 17/00

(52) U.S. Cl. CPC G06F 8/41; G06T 15/06; G06T 17/005

(57) ABSTRACT

This disclosure provides systems, devices, apparatus, and methods, including computer programs encoded on storage media, for unrolling an infinite loop during ray query traversal. A processor obtains, during a compile time, a number of loops associated with a BVH traversal based on a number of ray triangle intersections and a number of ray box intersections and/or a set of features associated with the BVH traversal and code generation associated with a shader. The processor determines, during the compile time, a loop unroll factor based on at least one of the obtained number of loops or the obtained set of features. The processor adjusts, during the compile time, a number of iterations of a loop associated with the BVH traversal based on the loop unroll factor. The processor outputs an indication of the adjusted number of iterations.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for ray traversal may not be able to determine an upper limit of iterations associated with ray traversal at a compile time. There is a need for improved ray tracing techniques at compile time.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: obtain, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader; determine, during the compile time, a loop unroll factor based on at least one of the obtained number of loops or the obtained set of features; adjust, during the compile time, a number of iterations of a loop associated with the BVH traversal based on the loop unroll factor; and output an indication of the adjusted number of iterations.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 is a diagram illustrating an example ray tracing process in accordance with one or more techniques of this disclosure.

FIG. 4A is a diagram illustrating an example rasterization process in accordance with one or more techniques of this disclosure.

FIG. 4B is a diagram illustrating an example ray tracing process in accordance with one or more techniques of this disclosure.

FIG. 5 is a diagram illustrating an example ray tracing process in accordance with one or more techniques of this disclosure.

FIG. 6A is a diagram illustrating an example data structure in accordance with one or more techniques of this disclosure.

FIG. 6B is a diagram illustrating an example data structure in accordance with one or more techniques of this disclosure.

FIG. 7A is a diagram illustrating an example bounding volume hierarchy (BVH) in accordance with one or more techniques of this disclosure.

FIG. 7B is a diagram illustrating another example BVH in accordance with one or more techniques of this disclosure.

FIG. 8A is a diagram illustrating an example of physically based rendering (PBR) in accordance with one or more techniques of this disclosure.

FIG. 8B is a diagram illustrating an example of forward ray tracing and backward ray tracing in accordance with one or more techniques of this disclosure.

FIG. 9 is a diagram illustrating an example of rasterization in accordance with one or more techniques of this disclosure.

FIG. 10 is a diagram illustrating an example of ray tracing in accordance with one or more techniques of this disclosure.

FIG. 11 is a diagram illustrating an example of path tracing in accordance with one or more techniques of this disclosure.

FIG. 12 is a diagram illustrating an example of aspects pertaining to BVHs in accordance with one or more techniques of this disclosure.

FIG. 13A is a diagram illustrating an example of aspects pertaining to acceleration structures in accordance with one or more techniques of this disclosure.

FIG. 13B is a diagram illustrating example aspects pertaining to acceleration structures in accordance with one or more techniques of this disclosure.

FIG. 14 is a diagram illustrating an example of a ray tracing pipeline in accordance with one or more techniques of this disclosure.

FIG. 15 is a diagram illustrating an example of a graphics, compute, or ray tracing pipeline in accordance with one or more techniques of this disclosure.

FIG. 16A is a diagram illustrating an example of aspects pertaining to a compiler in accordance with one or more techniques of this disclosure.

FIG. 16B is a diagram illustrating example aspects pertaining to a compiler in accordance with one or more techniques of this disclosure.

FIG. 17 is a diagram illustrating an example of profile guided optimization (PGO) based loop unrolling in accordance with one or more techniques of this disclosure.

FIG. 18 is a diagram illustrating an example of static heuristic based loop unrolling in accordance with one or more techniques of this disclosure.

FIG. 19 is a call flow diagram illustrating example communications between a compiler and a GPU in accordance with one or more techniques of this disclosure.

FIG. 20 is a flowchart of an example method of graphics processing in accordance with one or more techniques of this disclosure.

FIG. 21 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Ray tracing may refer to a technique for generating an image by tracing a path of light as the light bounces off an object. Ray tracing may be utilized to produce realistic lighting effects in various applications, including video game applications. In order to perform ray tracing, a device (e.g., a GPU) may traverse a bounding volume hierarchy (BVH). A BVH may refer to a tree structure on a set of geometric objects that are each recursively wrapped in bounding volumes until the entire set of geometric objects is wrapped in a single bounding volume. A traversal of the BVH may be referred to as a BVH traversal. During a BVH traversal with respect to a ray, an infinite loop may run until a triangle is hit which ends the traversal. As such, at a compile time, an upper limit of a number of iterations of the BVH traversal may not be known. As used herein, a compile time may refer to a period of time at which instructions are compiled (or prepared to be compiled) into machine-readable instructions. As used herein, a loop may refer to a control flow statement that specifies or is associated with an iteration. Loops may include for loops and while loops. A loop may include a specified or an unspecified number of iterations. A loop may be utilized to avoid duplication(s) of instructions.

Loop unrolling (i.e., unrolling a loop) may refer to a technique that attempts to optimize an execution speed of a program by reducing or eliminating instructions that control a loop, such as pointer arithmetic, end of loop tests on iterations of the loop, reducing branch penalties, and/or hiding latencies. As noted above, for a BVH traversal, an upper limit of a number of iterations of the BVH traversal may not be known. This may prevent a compiler from unrolling a loop associated with the BVH traversal. Failing to unroll a loop may impact a performance of a BVH traversal due to increased loop overhead.

Various technologies pertaining to unrolling an infinite loop during a ray query traversal are described herein. In an example, an apparatus (e.g., a CPU), obtains, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader. As used herein, a ray triangle intersection may refer to an intersection of a ray with a triangle. As used herein, a ray box intersection may refer to an intersection of a ray with a box (e.g., a bounding box, such as an axis aligned bounding box (AABB)). As used herein, a thread may refer to a sequence of programmed instructions that can be managed independently by a scheduler. As used herein, a shader may refer to a program executed by a graphics processor. As used herein, code generation may refer to generation of assembly code or machine code. The apparatus determines, during the compile time, a loop unroll factor based on at least one of the obtained number of loops or the obtained set of features. As used herein, a loop unroll factor may refer to data that facilitates unrolling a loop. A loop unroll factor may also refer to a factor by which a number of loop iterations are scaled down. The apparatus adjusts, during the compile time, a number of iterations of a loop associated with the BVH traversal based on the loop unroll factor. The apparatus outputs an indication of the adjusted number of iterations. Vis-à-vis determining the loop unroll factor based on at least one of the obtained number of loops or the obtained set of features and adjusting the number of iterations of the loop based on the unroll factor, the apparatus may optimize code generation. For instance, unrolling the loop based on the loop unroll factor may improve a shader execution time and hence an overall frame rate of an application. Furthermore, the improved code generation may also increase a power efficiency associated with executing a shader.

During ray traversal, an infinite loop may be run until a triangle is hit. A ray may go through a depth first search (DFS) traversal in a bounding volume hierarchy (BVH). An upper limit of iterations may be unknown, and as such, a loop may be unable to be unrolled at a compilation stage. In one aspect described herein, profiling may be used to determine a number of loops for unroll for a next iteration. In another aspect described herein, a static unroll may be performed based on heuristics from various applications/games.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

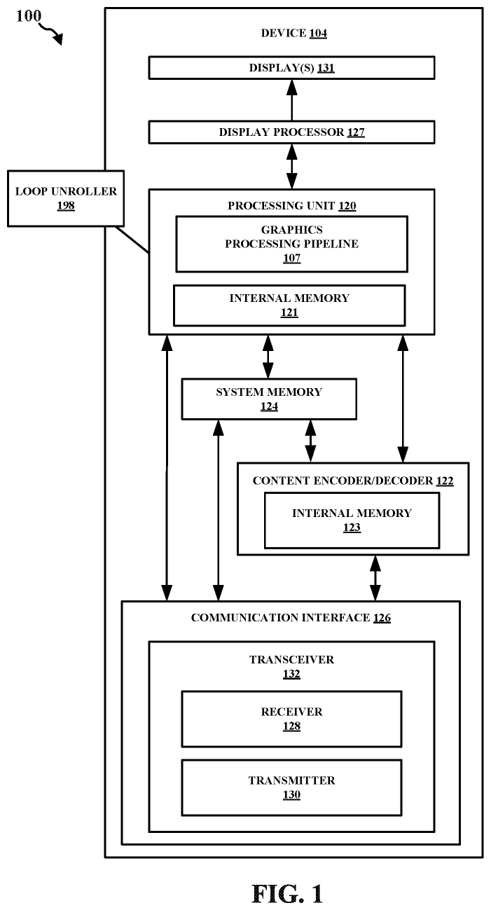

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a loop unroller 198 configured to obtain, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader; determine, during the compile time, a loop unroll factor based on at least one of the obtained number of loops or the obtained set of features; adjust, during the compile time, a number of iterations of a loop associated with the BVH traversal based on the loop unroll factor; and output an indication of the adjusted number of iterations. Although the following description may be focused on graphics processing, the concepts described herein may be applicable to other similar processing techniques. Furthermore, although the following description may be focused on ray tracing, the concepts presented herein may also be applicable to other types of tracing as well (e.g., path tracing).

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

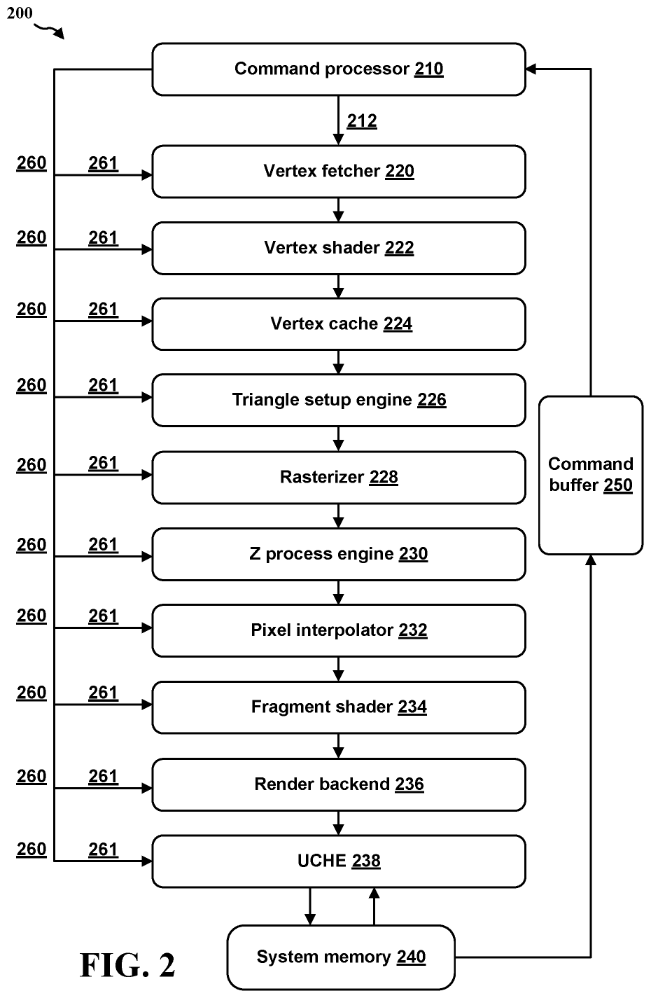

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

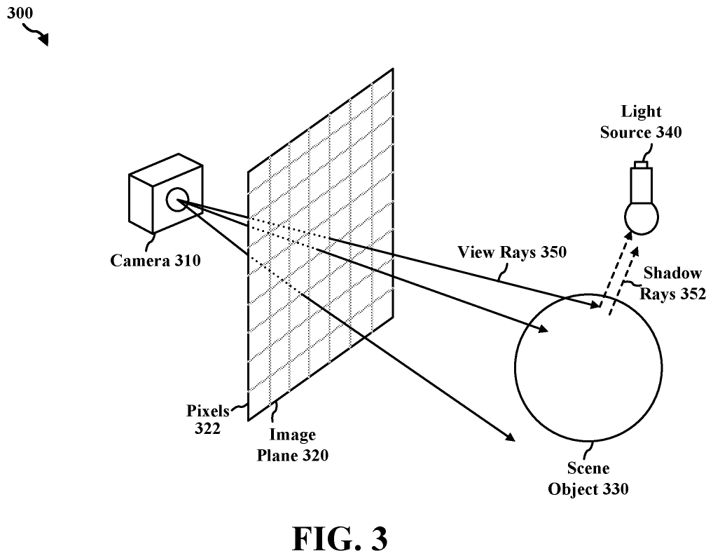

FIG. 3 illustrates diagram 300 including one example of a ray tracing process. As shown in FIG. 3, diagram 300 includes camera 310, image plane 320 including pixels 322, scene object 330, light source 340, view rays 350, and shadow rays 352. FIG. 3 shows that view rays 350 are traced from camera 310 and through image plane 320. After passing image plane 320, the view rays 350 are traced to scene object 330. At least some of the view rays 350 are traced off of scene object 330 and are traced towards light source 340 as shadow rays 352. Accordingly, the shadow rays 352 and view rays 350 may trace the light from light source 340. FIG. 3 depicts how ray tracing may generate an image by tracing the path of light (e.g., from light source 340) for the pixels in an image plane (e.g., pixels 322 in image plane 320).

Ray tracing is distinguishable from a number of other rendering techniques utilized in graphics processing, such as rasterization. In the process of rasterization, for each pixel in each primitive in a scene, the pixel may be shaded if a portion of the pixel is covered by the primitive. In contrast, in the process of ray tracing, for each pixel corresponding to a primitive in a scene, a ray is generated. If the generated ray is determined to hit or strike a certain primitive, then the pixel is shaded. In some instances of graphics processing, ray tracing algorithms may be performed alongside rasterization, such as via a hybrid ray tracing/rasterization model.

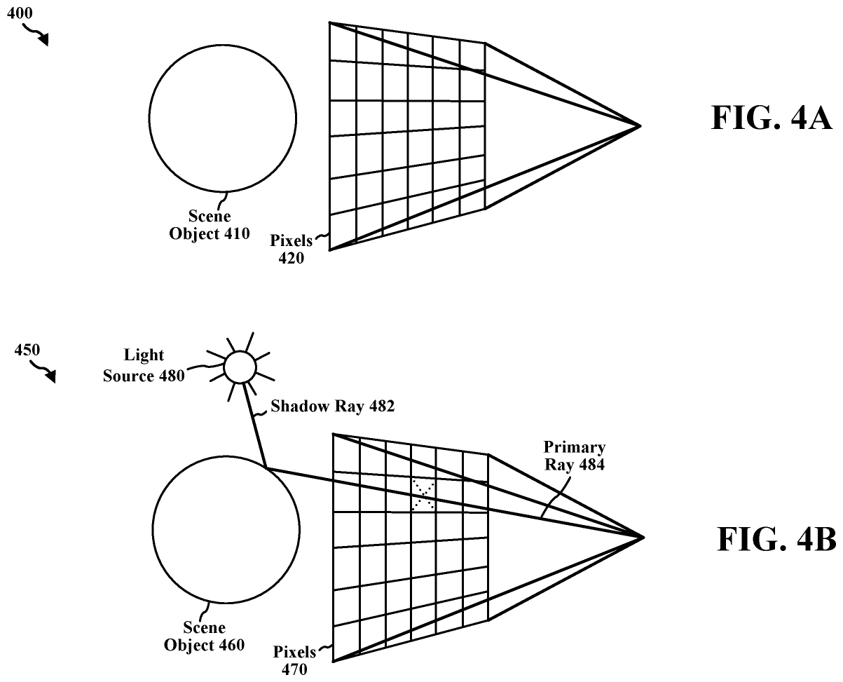

FIG. 4A and FIG. 4B illustrate a diagram 400 and a diagram 450 including an example process of rasterization and an example process of ray tracing, respectively. As shown in FIG. 4A, diagram 400 includes scene object 410 and pixels 420. FIG. 4A depicts that the process of rasterization determines, for each of pixels 420 in a scene including scene object 410, a pixel is shaded if a portion of the pixel is covered by a primitive. As shown in FIG. 4B, diagram 450 includes scene object 460, pixels 470, light source 480, shadow ray 482, and primary ray 484. FIG. 4B depicts that the process of ray tracing determines if a generated ray (e.g., shadow ray 482) will hit or strike a certain primitive in scene object 460 corresponding to one of the pixels 470 via primary ray 484, then the pixel is shaded.

As indicated herein, the process of ray tracing may be performed by determining whether a ray will hit/strike any primitive(s) in a scene. For example, ray tracing algorithms may perform a simple query operation: Is a given ray going to hit/strike any primitive(s) in a scene? The process of ray tracing is computationally intensive, as a large amount of rays may be traced against a large number of primitives/triangles, which may utilize a large number of ray-triangle intersection tests. For example, in one ray tracing procedure, approximately 1 million rays may be traced against approximately 1 million primitives/triangles, which may utilize approximately 1 trillion ray-triangle intersection tests. In some aspects of ray tracing procedures, an origin point for a given ray may be represented by O(N). Further, there may be a number of values calculated for the ray, such as a minimum time to strike primitives in a scene (tₘᵢₙ), a maximum time to strike primitives in a scene (tₘₐₓ), and a calculated distance to strike primitives in the scene.

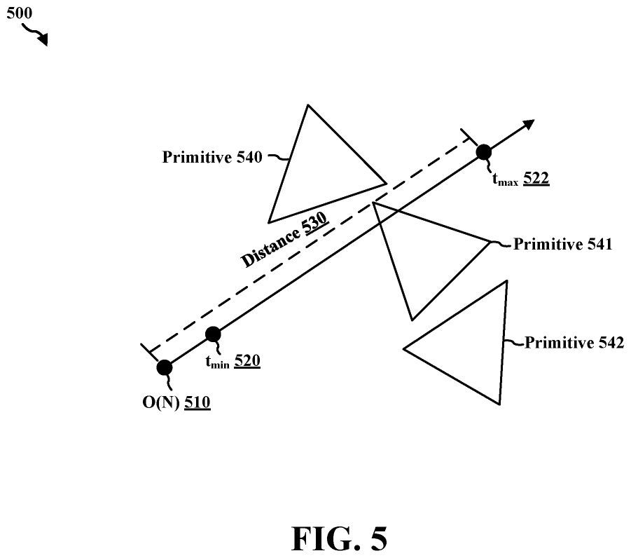

FIG. 5 illustrates a diagram 500 including one example of a ray tracing process. As shown in FIG. 5, the diagram 500 includes origin point for a ray (O(N)510), a minimum time to strike primitives in a scene (tₘᵢₙ 520), a maximum time to strike primitives in a scene (tₘₐₓ 522), a calculated distance to strike primitives in the scene (distance 530), and a number of primitives (primitive 540, primitive 541, and primitive 542) in the scene. FIG. 5 shows that ray tracing techniques may utilize a number of values to determine if a ray is going to hit a primitive. For instance, to determine if a ray will strike a primitive, ray tracing techniques may utilize an origin point for a ray (O(N)510), a minimum time to strike primitives (tₘᵢₙ 520), a maximum time to strike primitives (tₘₐₓ 522), a calculated distance to strike primitives (distance 530), and a number of primitives (primitive 540, primitive 541, and primitive 542).

Ray tracing may utilize various data structures for accelerating a computational process, such as a bounding volume hierarchy (BVH). In a bounding volume hierarchy, primitives are held in leaf nodes. Further, internal nodes may hold access aligned bounding boxes (AABBs) that enclose certain leaf node geometry. Data structures for ray tracing may also utilize a ray-box intersection for internal nodes and/or a ray-triangle test for leaf nodes. These types of data structures may reduce the computational complexity (N) of the ray tracing process, e.g., reduce the computational complexity (N) by log (N).

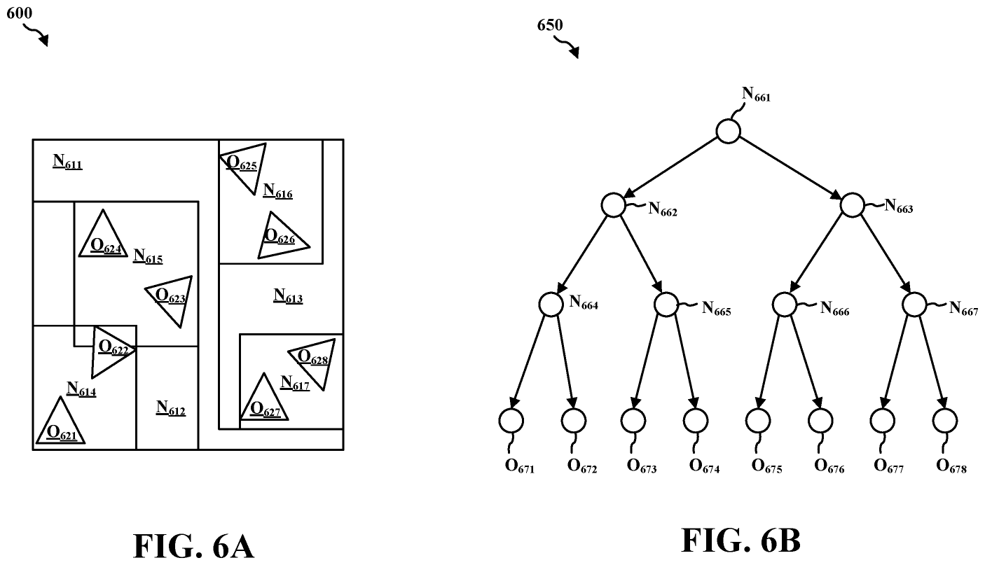

FIG. 6A and FIG. 6B illustrate a diagram 600 and a diagram 650, respectively, including example data structure techniques utilized in ray tracing. As shown in FIG. 6A, diagram 600 includes a number of nodes (internal nodes N₆₁₁-N₆₁₇) and a number of primitives (primitives O₆₂₁-O₆₂₈). FIG. 6A depicts a ray-box intersection for internal nodes N₆₁₁-N₆₁₇ and primitives O₆₂₁-O₆₂₈. As shown in FIG. 6B, diagram 650 includes a number of nodes (leaf nodes N₆₆₁-N₆₆₇) and a number of primitives (primitives O₆₇₁-O₆₇₈). FIG. 6B depicts a ray-triangle test for leaf nodes N₆₆₁-N₆₆₇ and primitives O₆₇₁-O₆₇₈. Both of the data structure techniques in FIGS. 6A and 6B, e.g., the ray-box intersection and the ray-triangle test, aim to reduce the computational complexity in ray tracing.

As indicated herein, there are a number of different stages during a ray tracing process. For example, the stages of ray tracing may include: bounding volume hierarchy construction and refinement, ray generation, bounding volume hierarchy traversal, ray-triangle intersection, and ray-box intersection. There may also be different steps during bounding volume hierarchy construction, including partitioning triangles into multiple groups, forming a bounding box around each group, and recursively partitioning each group. Additionally, there may be several ways to partition during bounding volume hierarchy construction, which may result in a certain number of possible solutions, e.g., 2^{n log n} solutions. As a result, these improved solutions may yield improved ray tracing performance.

Aspects of ray tracing may also utilize a number of bounding volume hierarchy algorithms, such as split bounding volume hierarchy (SBVH) and linear bounding volume hierarchy (LBVH). In some instances, SBVH may result in slower build times and better quality compared to LBVH. Likewise, LBVH may result in faster build times and poorer quality compared to SBVH. Additionally, some aspects of ray tracing may utilize bounding volume hierarchy refinement. In bounding volume hierarchy refinement, given a binary BVH with one triangle per leaf, ray tracing techniques may permute the tree topology. Bounding volume hierarchy refinement may utilize different algorithms, e.g., a treelet restructuring BVH (TRBVH) and a parallel reinsertion BVH (PRBVH). Some aspects of ray tracing may also utilize BVH widening, which may convert a binary tree (i.e., an initial BVH) to a wide BVH that is wider than the binary tree or initial BVH. For example, hierarchy in the initial BVH may include three levels, where the primitives are included in a third level of the hierarchy. The hierarchy in the wide BVH may include two levels, where the primitives are included in a second level of the hierarchy. In some instances of BVH widening, the wide BVH may include an internal node with a certain amount of AABBs (e.g., up to eight AABBs) and a leaf node with a certain amount of primitives/triangles (e.g., up to four primitives/triangles).

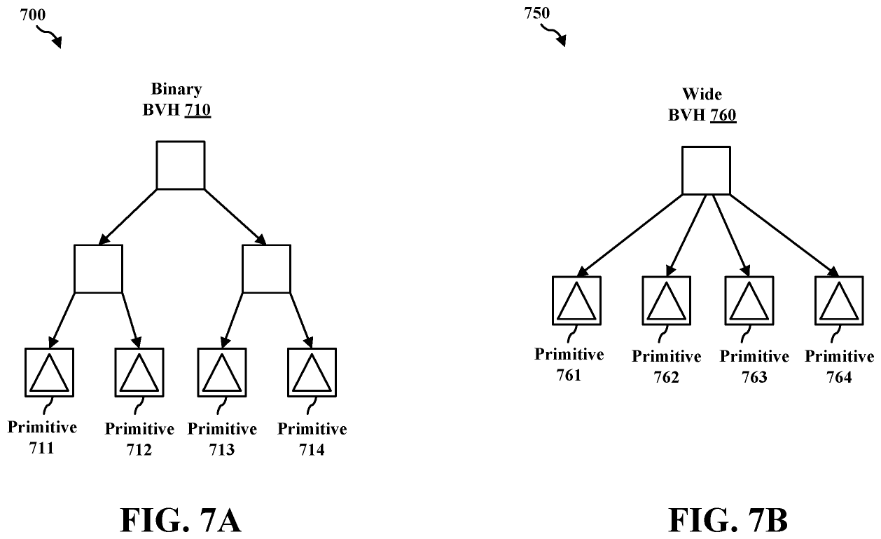

FIG. 7A and FIG. 7B illustrate a diagram 700 and a diagram 750 including a binary bounding volume hierarchy and a wide bounding volume hierarchy, respectively. As shown in FIG. 7A, diagram 700 includes a binary bounding volume hierarchy 710 including primitive 711, primitive 712, primitive 713, and primitive 714. FIG. 7A depicts that binary bounding volume hierarchy 710 includes three levels, where primitives 711-714 are in the third level of the hierarchy. As shown in FIG. 7B, diagram 750 includes a wide bounding volume hierarchy 760 including primitive 761, primitive 762, primitive 763, and primitive 764. FIG. 7B depicts that wide bounding volume hierarchy 760 includes two levels, where primitives 761-764 are in the second level of the hierarchy. As shown in FIGS. 7A and 7B, binary bounding volume hierarchy 710 may undergo a process of bounding volume hierarchy widening that results in wide bounding volume hierarchy 760.

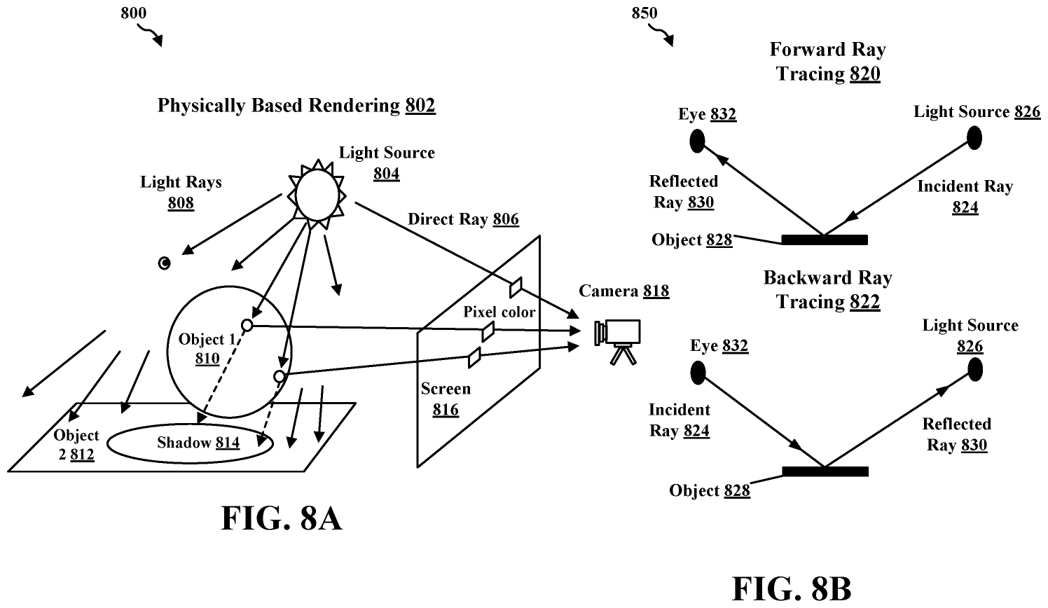

FIG. 8A is a diagram 800 illustrating an example of physically based rendering (PBR) 802 in accordance with one or more techniques of this disclosure. PBR may refer to a computer graphics approach that seeks to render images in a manner that models light and surfaces with optics in the real world. PBR may also be referred to as “physically based lighting” or “physically based shading.” PBR principles may be associated with ray tracing and path tracing. PBR may produce realistic lighting effects; however, PBR may be computationally intensive due to large numbers of light rays (e.g., infinitely many light rays).

In the PBR 802, a light source 804 may project rays in different directions. The rays may include a direct ray 806 and light rays 808. The light rays 808 may include an infinite number of rays. In an example, some of the light rays 808 may be reflected off of a first object 810, and other light rays may be reflected off of a second object 812. The first object 810 may block some of the light rays 808 from reaching the second object 812, which may create a shadow 814 (i.e., a no-light region) on the second object 812. A pixel color (i.e., a shading color) of the direct ray 806 on a screen 816 from the perspective of a camera 818 (i.e., an eye of an observer) may be based on a color of the direct ray 806. A pixel color (i.e., a shading color) of light rays 808 that are reflected off of the first object 810 on the screen 816 from the perspective of the camera 818 may be based on a light-material interaction of the light rays 808 with the first object 810.

FIG. 8B is a diagram 850 illustrating an example of forward ray tracing 820 and backward ray tracing 822 in accordance with one or more techniques of this disclosure. In the forward ray tracing 820, an incident ray 824 may be cast from a light source 826. The incident ray 824 may reflect off of an object 828, thereby producing a reflected ray 830 that may be observed by an eye 832. In the backward ray tracing 822, the incident ray 824 may be cast from the eye 832 to the object 828. The incident ray 824 may be reflected from the object 828, thereby producing the reflected ray 830 that originates from the light source 826.

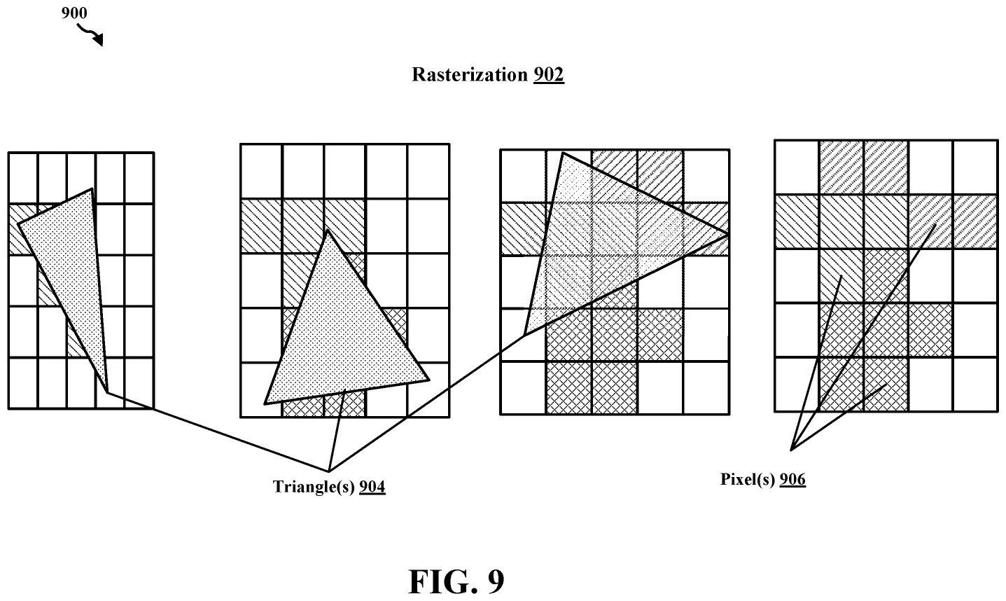

FIG. 9 is a diagram 900 illustrating an example of rasterization 902 in accordance with one or more techniques of this disclosure. In the rasterization 902, vertices of triangle(s) 904 (or another polygon) in three dimensions may be converted into two-dimensional (2D) pixel(s) 906 in an image. Stated differently, the rasterization 902 may be associated with the following pseudocode listed below:

### Rasterization Loop:

For each object
For each pixel—closer?

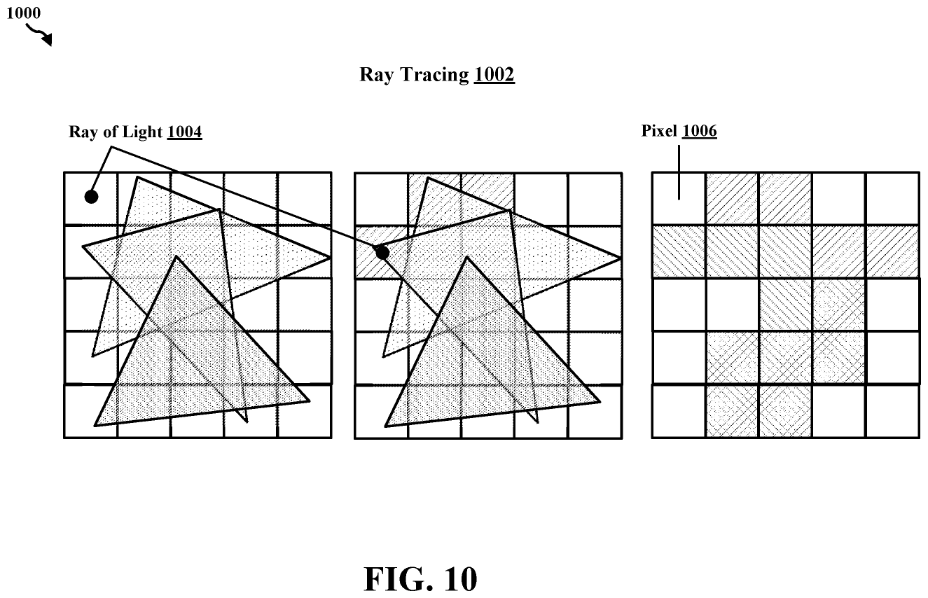

FIG. 10 is a diagram 1000 illustrating an example of ray tracing 1002 in accordance with one or more techniques of this disclosure. In the ray tracing 1002, a ray of light 1004 may be projected (i.e., shot) from each pixel in an image and traced through a scene to determine if the ray of light (after multiple bounces) and/or a final bounce would be able to reach a light source in the scene. In an example, the ray of light 1004 may be able to reach a light source in the scene, and hence a pixel 1006 may be shaded. Stated differently, the ray tracing 1002 may be associated with the following pseudocode listed below:

### Ray Tracing Loop:

For each pixel
For each object—closest?

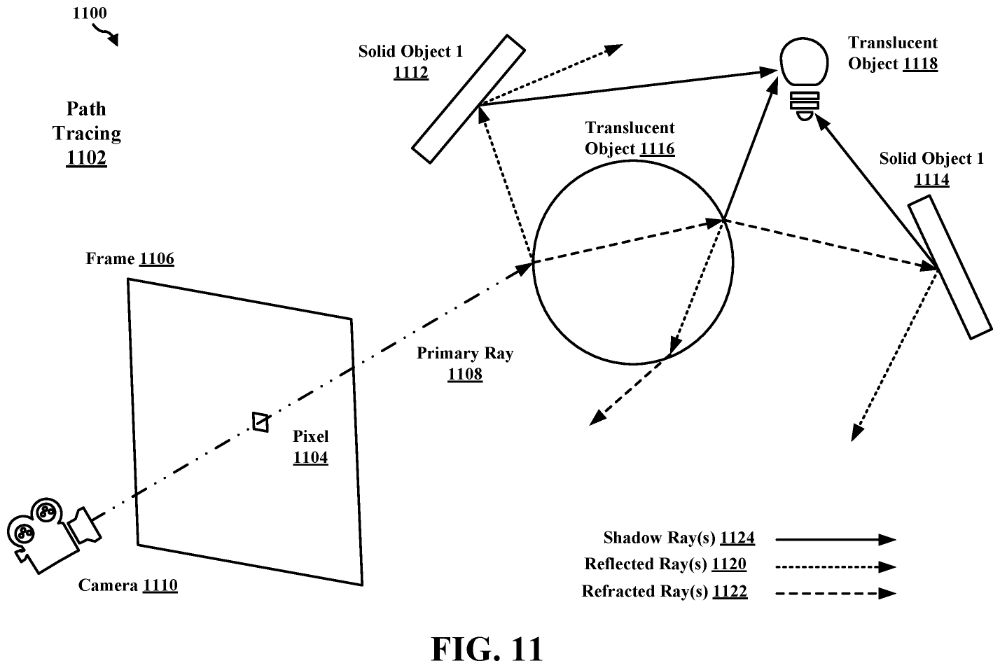

FIG. 11 is a diagram 1100 illustrating an example of path tracing 1102 in accordance with one or more techniques of this disclosure. Path tracing may refer to a computer graphics Monte Carlo method of rendering three-dimensional (3D) scenes such that a global illumination is faithful to reality. Path tracing may involve integrating over all illuminance arriving at a single point on a surface of an object. The illuminance may then be reduced by a surface reflectance function (e.g., a bidirectional reflectance distribution function (BRDF)) to determine an amount of illuminance that is oriented towards a viewpoint camera. This procedure may be repeated for every pixel in an output image. Path tracing may differ from ray tracing in that instead of following a large number of rays throughout an entire scene, path tracing may sample out a most likely path for light.

In the path tracing 1102, for a pixel 1104 of a frame 1106, a primary ray 1108 may be cast from a camera 1110 toward a scene, where the scene may include a first solid object 1112, a second solid object 1114, a translucent object 1116, and a light source 1118. As used herein, a frame may refer to an image. The primary ray 1108 may reflect or refract off of the translucent object 1116 to produce reflected ray(s) 1120 and refracted ray(s) 1122, respectively. The reflected ray(s) 1120 and/or the refracted ray(s) 1122 may be associated with shadow ray(s) 1124 corresponding to the light source 1118.

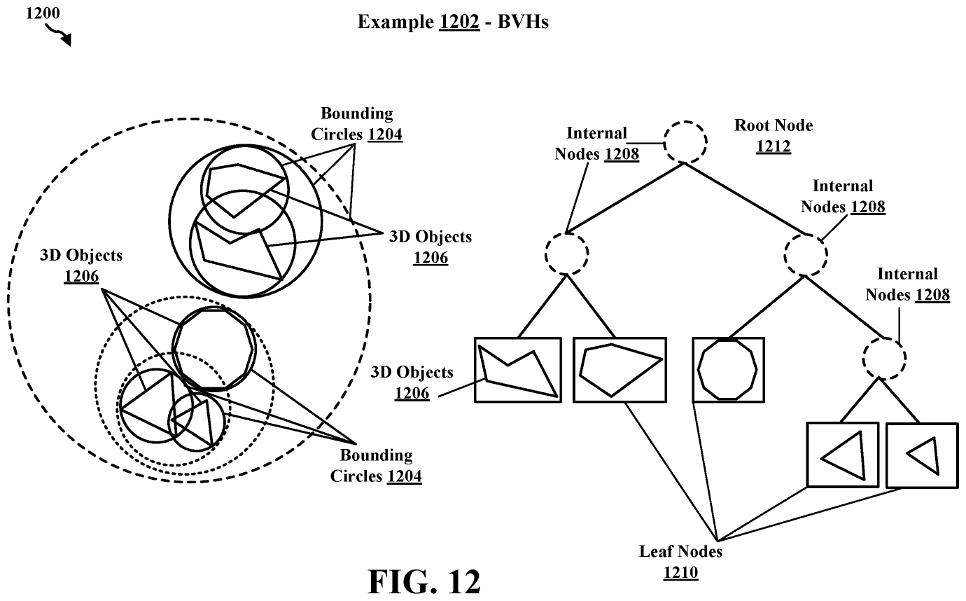

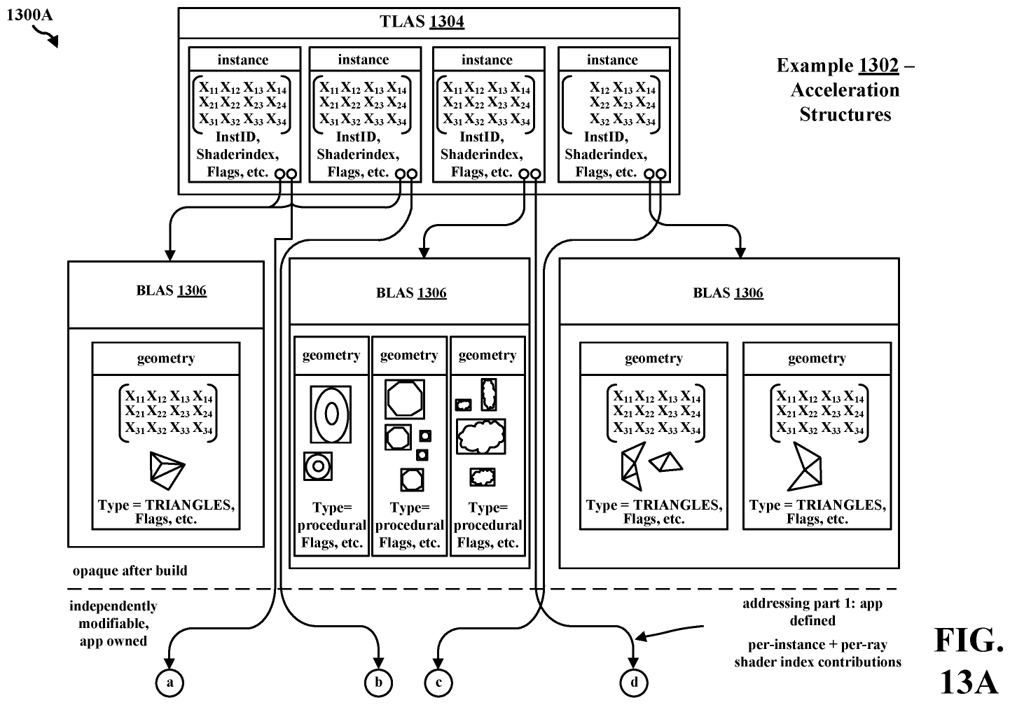

FIG. 12 is a diagram 1200 illustrating an example 1202 of aspects pertaining to BVHs in accordance with one or more techniques of this disclosure. A BVH may refer to an acceleration structure used in ray tracing. A BVH may be a hierarchical grouping of 3D objects, where each group may be associated with a bounding box (e.g., a conservative bounding box). Traversing a BVH (i.e., tracing a ray) may have an O (log N) computational cost. The example 1202 depicts bounding circles 1204 that hierarchically enclose 3D objects 1206. The example 1202 also depicts internal nodes 1208 of a BVH and leaf nodes 1210 of the BVH. Each leaf node in the leaf nodes 1210 may enclose a single 3D object in the 3D objects 1206. Each internal node in the internal nodes 1208 may encompass more than one 3D object in the 3D objects 1206. The internal nodes 1208 may include a root node 1212 that encompasses all of the 3D objects 1206.

In an example with respect to BVHs, a list of bounding volumes (BVs) may be generated before ray tracing. The list of BVs may be cuboids that surround objects in a scene. Successively smaller cuboids may be generated for various structures within an object. In an example, an object may be a rabbit. A first BV may be generated that covers an entirety of the rabbit. A first set of BVs may then be generated that cover different body parts of the rabbit. For example, the first set of BVs may include BVs that cover a head, legs, a torso, a tail, etc. of the rabbit. A second set of BVs may then be generated that cover different areas of the body parts. For example, a second set of BVs for the head may cover eyes, a nose, and a mouth of the rabbit. This process may continue until a final volume is generated that includes a relatively small number of triangles to test. The BVs may be arranged in an ordered list (which may be referred to as a BVH) such that a system may check a relatively small number of BVs.

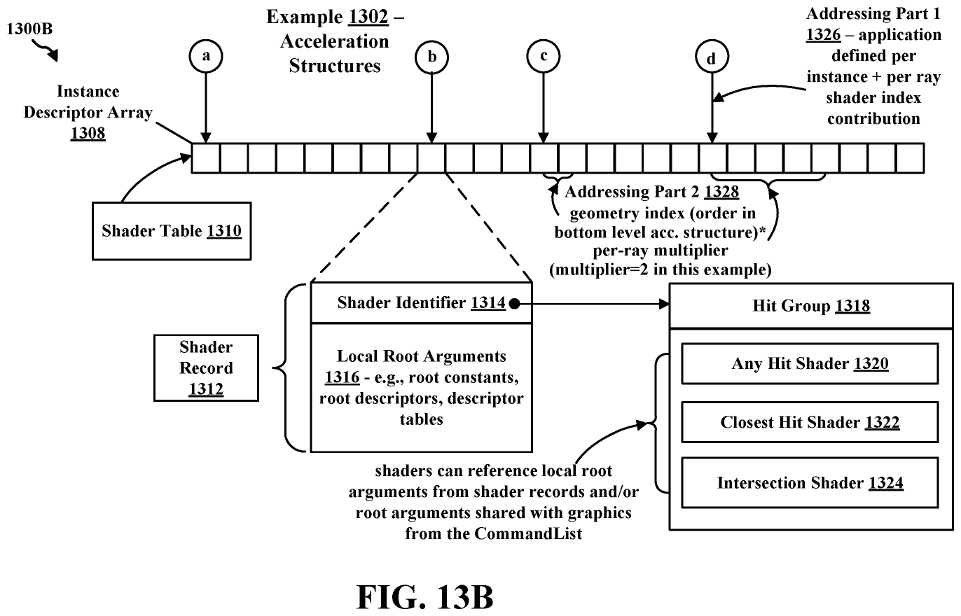

FIG. 13A is a diagram 1300A illustrating an example 1302 of aspects pertaining to acceleration structures in accordance with one or more techniques of this disclosure. An acceleration structure may refer to a spatial data structure that speeds up searches for polygons (e.g., triangles), distance fields, etc. in a given scene. A BVH may be an example of an acceleration structure. A scene graph and instancing may be handled using a two-level acceleration structure system. The two-level acceleration structure system may include a top-level acceleration structure (TLAS) 1304 that is in world space. Primitives of the TLAS 1304 may be instances of at least one bottom-level acceleration structure (BLAS) 1306. For each scene object (e.g., a set of geometries, such as draw calls), an application may provide triangles (or flags) or AABBs of procedural primitives (or AABBs of flags), and the at least one BLAS 1306 may be constructed over the procedural primitives. The TLAS 1304 and the at least one BLAS 1306 may be opaque after the TLAS 1304 and the at least one BLAS 1306 are built.

The TLAS 1304 may be created in a similar manner as the at least one BLAS 1306. An object to world matrix may be provided for each instance and may be used to compute a world space AABB of the instance. A BVH may be constructed over each instance. A scene description may be a hierarchical structure rooted at a TLAS descriptor. The scene description may include the TLAS 1304, the at least one BLAS 1306, and an instance descriptor array (described below).

FIG. 13B is a diagram 1300B illustrating example aspects pertaining to acceleration structures in accordance with one or more techniques of this disclosure. As described above, a scene description may include an instance descriptor array, such as an instance descriptor array 1308. The instance descriptor array 1308 may be “application owned,” that is, the instance descriptor array 1308 may be independently modifiable.

The instance descriptor array 1308 may include a shader table 1310. The instance descriptor array 1308 may also include a shader record 1312. The shader record 1312 may include a shader identifier 1314. The shader record 1312 may also include local root arguments 1316, such as root constants, root descriptors, and descriptor tables. The shader identifier 1314 may be associated with a hit group 1318. The hit group 1318 may include an any hit shader 1320 and a closest hit shader 1322. For procedural primitives, the hit group 1318 may include an intersection shader 1324. Shaders in the hit group 1318 may reference local root arguments from shader records (e.g., the shader record 1312) and/or root arguments shared with graphics from a command list.

The instance descriptor array 1308 may be associated with a first addressing part 1326 and a second addressing part 1328. The first addressing part 1326 may be application defined. The first addressing part 1326 may be associated with per instance and per ray shader index contributions. The second addressing part 1328 may be a geometry index (i.e., an order in a BLAS) multiplied by a per ray multiplier (e.g., times two).

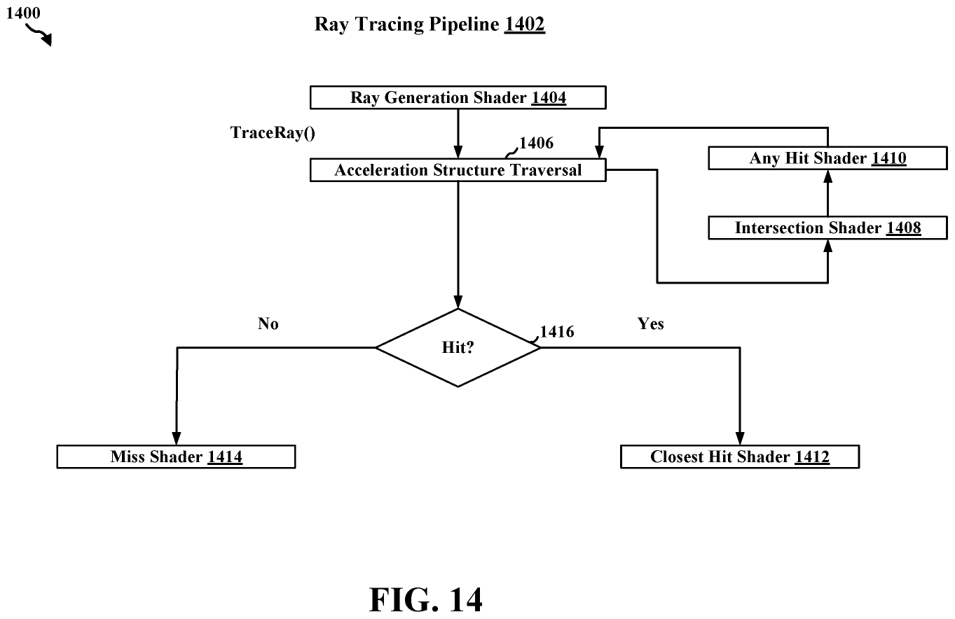

FIG. 14 is a diagram 1400 illustrating an example of a ray tracing pipeline 1402 in accordance with one or more techniques of this disclosure. In an example, the ray tracing pipeline 1402 may be implemented on the device 104. The ray tracing pipeline 1402 may include a ray generation shader 1404. The ray generation shader 1404 may generate primary rays. When a “TraceRay( )” function is called, a device may perform an acceleration structure traversal 1406.

The ray tracing pipeline 1402 may include an intersection shader 1408 and an any hit shader 1410. The intersection shader 1408 may determine whether a ray intersects procedural geometry of a scene. The intersection shader 1408 may not be able to trace new rays or call callable shaders. The intersection shader 1408 may implicitly call the any hit shader 1410 via a report hit mechanism. The any hit shader 1410 may be called for each intersection of a ray with geometry (e.g., procedural geometry) of a scene. The any hit shader 1410 may not be able to trace new rays or call callable shaders. The any hit shader 1410 may determine whether a traversal (e.g., a traversal of a BVH) should continue or end.

A closest hit shader 1412 or a miss shader 1414 may be called based on whether the acceleration structure traversal 1406 produces a hit at 1416. The closest hit shader 1412 may be called for an intersection (of a ray and a BV) with a lowest TMax value. The TMax value may be equivalent to a far clipping plane. In one aspect, TMax may refer to a distance traveled by light for a triangle intersection. In another aspect, TMax may be a variable that represents a maximum distance a ray is able to travel before the ray is terminated. A value of TMax (i.e., a TMax value) may be initialized to a large number and may be reduced as a ray intersects with objects in a scene. When the ray intersects with an object, the value of TMax may be updated to a distance between an origin of a ray and an intersection point. This may help to facilitate that the ray is not tested against objects that are farther way than a closest intersection point. The closest hit shader 1412 may be configured to trace new rays. The miss shader 1414 may be called when an intersection of a ray with a BV is not found. The miss shader 1414 may be able to trace new rays.

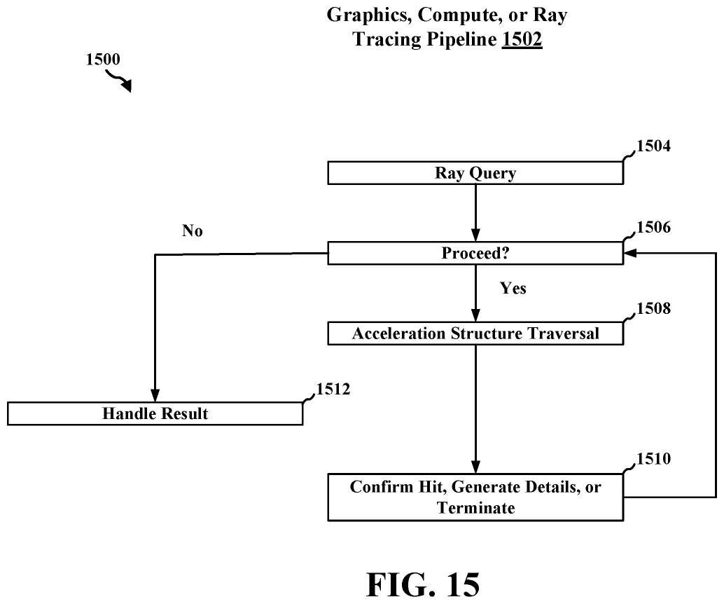

FIG. 15 is a diagram 1500 illustrating an example of a graphics, compute, or ray tracing pipeline in accordance with one or more techniques of this disclosure. The graphics, compute, or ray tracing pipeline 1502 may be associated with inline ray tracing. Inline ray tracing may refer to an alternative form of ray tracing that does not utilize separate dynamic shaders or shader tables. Inline ray tracing may be available at different shader stages, such as a compute shader stage, a pixel shader stage, etc. In the graphics, compute, or ray tracing pipeline 1502, at 1504, a ray query may be performed. At 1506, a decision as to whether proceed with an acceleration structure traversal may be performed. Upon positive determination, at 1508, the acceleration structure traversal may be performed. At 1510, a hit may be confirmed, details pertaining to a hit or miss may be generated, or the acceleration structure traversal may be terminated. The graphics, compute, or ray tracing pipeline 1502 may then return to 1506. Returning to 1506, upon negative determination, at 1512 a result of the acceleration structure traversal may be handled.

In one aspect, a TLAS to BLAS transition may be performed by a device. The TLAS to BLAS transition may include transforming a ray from a world space to an object space. Transforming the ray from the world space to the object space may be associated with a first vector corresponding to a ray origin, a second vector corresponding to a ray direction, and a matrix multiplication. In one aspect, the matrix multiplication may be performed by a ray tracing unit (RTU). In such an aspect, the RTU may be configured to fetch a matrix, perform matrix multiplication with respect to a ray, and return the transformed ray.

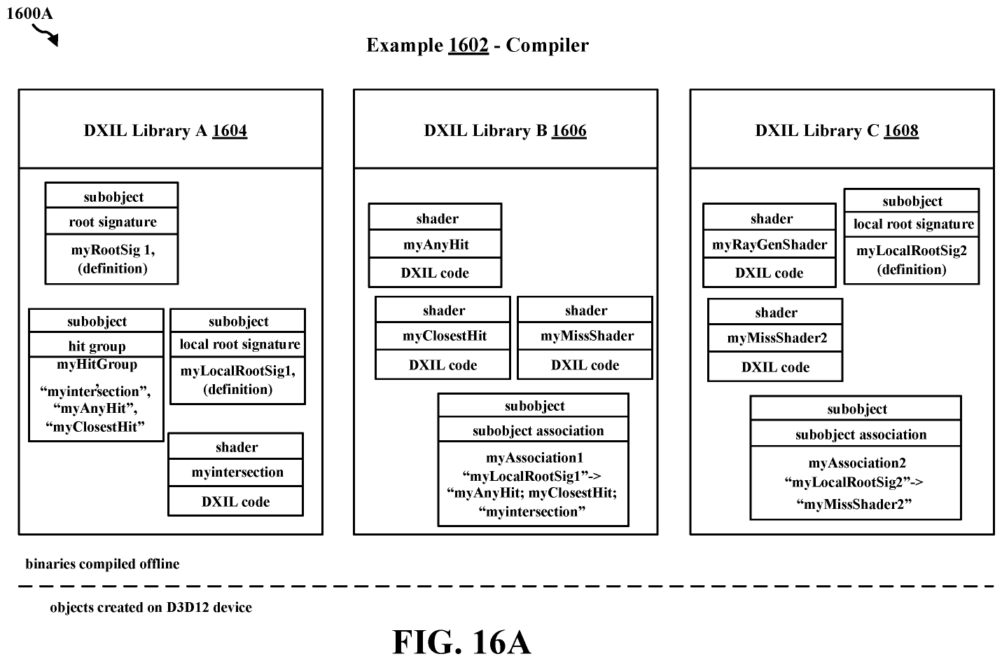

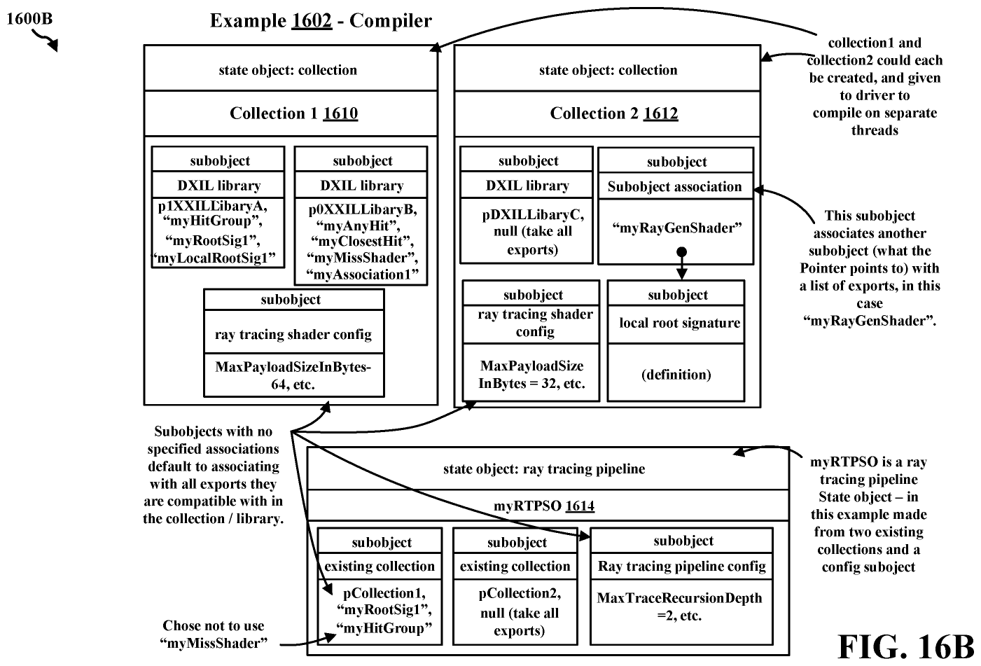

FIG. 16A is a diagram 1600A illustrating an example 1602 of aspects pertaining to a compiler in accordance with one or more techniques of this disclosure. The example 1602 depicts DirectX Intermediate Language (DXIL) Library A 1604, DXIL Library B 1606, and DXIL Library C 1608. DXIL Library A 1604, DXIL Library B 1606, and DXIL Library C 1608 may be binaries that are compiled offline.

FIG. 16B is a diagram 1600B illustrating example aspects pertaining to a compiler in accordance with one or more techniques of this disclosure. As noted above, DXIL Library A 1604, DXIL Library B 1606, and DXIL Library C 1608 may be binaries that are compiled offline. For instance, during a create state object stage (i.e., “CreateStateObject( )”), a driver may call a compiler to perform a compilation. The compilation may support two types of state objects: collection and ray tracing pipeline. For a collection, the compiler may complete all exports specified in a state object. The compiler may also save DXIL and an intermediate binary compilation (BC) to assist in linking future state objects. A ray tracing pipeline may be similar to a collection; however, for a tracing pipeline, the compiler may also generate code for a traversal (e.g., a BVH traversals) and for bucketing kernels. State objects may be dependent on results of previous state object compilations. To facilitate the aforementioned dependence, the compiler may provide the driver with an opaque buffer that may include data that the compiler is to access from a previous state object. The compiler may load the data to link a new state object.

In an example, the compiler may compile a first collection 1610, a second collection 1612, and a ray tracing pipeline (referred to in FIG. 16B as “myRTPSO 1614”). The first collection 1610, the second collection 1612, and myRTPSO 1614 may be objects created on a Direct3D 12 (D3D12) device. The first collection 1610 and the second collection 1612 may be provided to the driver to compile on separate threads. In an example, myRTPSO 1614 may be a ray tracing pipeline state object that is made from two existing collections (e.g., the first collection 1610 and the second collection 1612) and a configuration subobject. Subobjects with no specified association may default to associating with exports that are compatible with a collection/library. In an example, myRTPSO 1614 may indicate that a shader is not to be used, such as “myMissShader.” In an example, a subject may be associated with another subobject (i.e., what a pointer points to) that is associated with a list of exports, such as “myRayGenShader.”

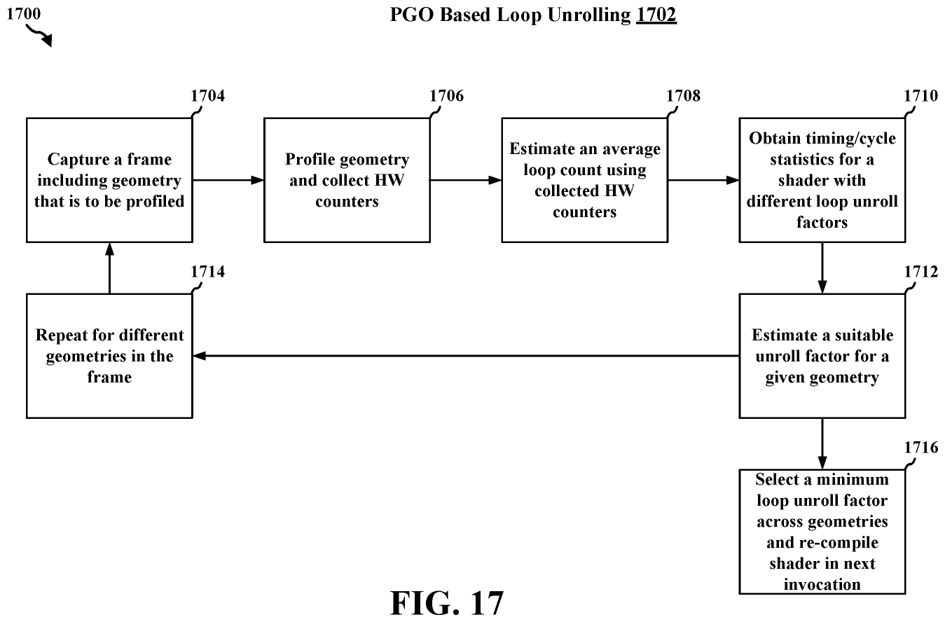

FIG. 17 is a diagram 1700 illustrating an example of profile guided optimization (PGO) based loop unrolling 1702 in accordance with one or more techniques of this disclosure. A device may perform a ray traversal using the following ray traversal pseudocode listed below:

```
while(rayQueryProceedEXT (rayQuery)) {
  if(rayQueryGetIntersectionTypeEXT (rayQuery, false) ==
    gl_RayQueryCandidateIntersectionTriangleEXT)
  {
    ... // Determine if an opaque triangle hit occurred
    if (opaqueHit) rayQueryConfirmIntersectionEXT (rayQuery);
  }
  else if (rayQueryGetIntersectionTypeEXT(rayQuery, false) ==
      gl_RayQueryCandidateIntersectionAABBEXT)
  {
    ... // Determine if an opaque hit occurred in an AABB
    if (opaqueHit) rayQueryGenerationIntersectionEXT(rayQuery, ...);
  }
}
}
```

During a ray traversal (e.g., “rayQueryProceedEXT” in the ray traversal pseudocode listed above), an infinite loop may execute until a triangle is hit which ends the traversal. With more particularity, the ray traversal pseudocode listed above (which may be shader code executed by a shader processor) may perform a depth first search (DFS) through a BVH (e.g., a BVH tree), such as the BVH described above in connection with FIG. 6A and FIG. 6B. An upper limit of a number of iterations of a loop associated with the DFS may not be known at a compilation stage. As such, the loop may not be unrolled at the compilation stage, which may impact performance due to increased loop overhead. With more particularity, if a loop associated with a BVH traversal is not unrolled, loop overhead (e.g., branching to a top of the loop, checking for exit conditions, etc.) may be executed more frequently in a loop that is not unrolled compared to a loop that is unrolled.

Loop unrolling (which may also be referred to as loop unwinding) may refer to a technique that attempts to optimize an execution speed of a program by reducing or eliminating instructions that control a loop, such as pointer arithmetic, end of loop tests on iterations of the loop, reducing branch penalties, and/or hiding latencies. Loop unrolling may be performed by a compiler. In an example, a compiler may be presented with the following while loop (i.e., a normal while loop):
while (condition) do
   action
end while

The compiler may unroll the above-referenced while loop to produce the following unrolled while loop:
while (condition) do
   action
   if not (condition) then goto break
   action
   if not (condition) then goto break
   action
end while
label break:

The unrolled while loop may be more efficient than the normal while loop, as “end while” (a jump to the start of the while loop) of the unrolled while loop may be executed 66% less often than the “end while” of the normal while loop.

Some aspects presented herein pertain to utilizing profile guided optimization (PGO) to unroll a loop associated with a BVH traversal. PGO (which may also be referred to as pogo, profile-directed feedback, or feedback-directed optimization) may refer to a compiler optimization technique used in computer programming that uses profiling (e.g., space and/or time complexity of a program, usage of particular instructions, frequency and/or direction of function calls, etc.) to improve program runtime performance. Rather than using programmer-supplied frequency information, PGO may use results of profiling test runs of an instrumented program to optimize final generated code. In PGO, a compiler may access profile data of a sample run of a program across a representative input set. Results of the sample run may indicate areas of the program that are executed frequently and areas of the program that are executed less frequently. PGO may also refer to an optimization performed after profiling a program at runtime and/or at compile time. A just-in-time (JIT) compiler may make use of runtime information to dynamically recompile parts of executed code to generate a more efficient native code. If a dynamic profile (e.g., a PGO profile) changes during execution of a program, the JIT compiler may deoptimize previous native code and generate new code optimized with information from the changed dynamic profile.

In one aspect presented herein, a loop count associated with a BVH traversal may be estimated via profiling a shader. The estimated loop count may be used to unroll the loop during subsequent calls to a compiler using PGO. With more particularity, the ray traversal pseudocode listed above may generate a first loop of instructions (i.e., an inner loop) and a second loop of instructions (i.e., an outer loop). The inner loop generated by “rayQueryProceedExt” may iterate over a BVH (i.e., a BVH tree). The inner loop may include a ray intersection instruction which may offload an intersection test for a box and a triangle to a ray tracing unit (RTU). An RTU may refer to hardware that is configured to facilitate ray tracing. An RTU may be included in a GPU. An example of a ray intersection instruction generated by the inner loop may be “ray_intersection r5.x, [r2.z], r12.x, r0.z, r12.y;.” The outer loop may behave similar to an any hit shader (e.g., the any hit shader 1410). The outer loop may control a traversal of a BVH to end after finding a closest opaque triangle. Hardware counters (e.g., special purpose registers that store counts of hardware-related activities) may determine (e.g., estimate) a loop count (e.g., an average loop count) associated with the ray traversal pseudocode according to equation (I) below.

Loop Count=(Number Ray Box Intersections+Number of Ray Triangle Intersections)/Number of Threads (I)

In an example, the number of ray box intersections and the number of ray triangle intersections may be associated with a shader processor (SP) and/or an RTU.

A description of the PGO based loop unrolling 1702 is now set forth. At 1704, a device may capture a frame that includes geometry (from amongst multiple geometries) that is to be profiled. In one aspect, the frame may be a representative frame from an application that is sampled from a set of frames. At 1706, the device may profile the geometry and collect hardware (HW) counters. The HW counters may be GPU HW counters. The HW counters may be indicative of HW usage (e.g., memory usage, instruction size, etc.) associated with the geometry. At 1708, the device may estimate an average loop count using the collected HW counters. With more particularity, the device may obtain, via the HW counters, an indication of a number of ray box intersections and an indication of a number of ray triangle intersections. The device may also obtain an indication of a number of threads. The device may estimate the average loop count according to equation (I) above. At 1710, the device may obtain timing/cycle statistics for a shader with different loop unroll factors. In one aspect, a maximum loop unroll factor may be equal to the average loop count. At 1712, the device may estimate a suitable unroll factor for a given geometry. For instance, the device may run the application using different unroll factors. The device may estimate the suitable unroll factor based on performance of the application using the different unroll factors. For example, the suitable unroll factor may produce a highest performance (e.g., a faster shader execution time, a fastest frame rate, a lowest power consumption, etc.) when the application is run. At 1714, the device may repeat 1704, 1706, 1708, and 1712 for different geometries in the frame. At 1716, the device may select a minimum loop unroll factor across the geometry and the different geometries (i.e., across different captures) and the device may re-compile the shader in a next invocation of the shader using the minimum loop unroll factor.

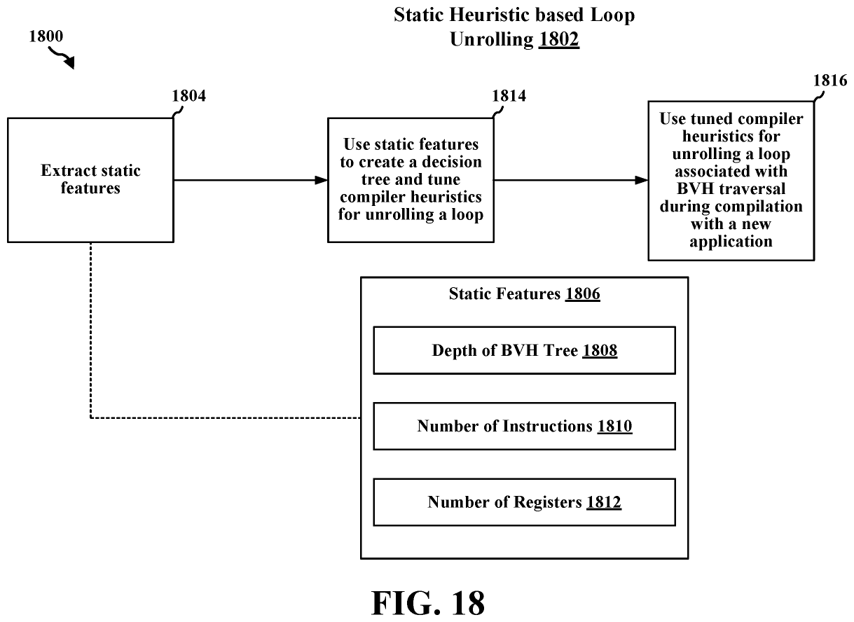

FIG. 18 is a diagram 1800 illustrating an example of static heuristic based loop unrolling 1802 in accordance with one or more techniques of this disclosure. At 1804, a device may extract static features 1806 associated with a BVH. The static features 1806 may be known prior to a compile time. The static features 1806 may include a depth of a BVH tree 1808. As used herein, a depth (i.e., a height) of a BVH tree may refer to a number of edges from a root node to a leaf node (or another non-root node) of the BVH. In an example, the depth of the BVH tree 1808 may be an average depth of BVH trees across geometries in an application. The average depth of BVH trees may correspond to an average number of hops during ray traversal. The static features 1806 may also include a number of instructions 1810 and a number of registers 1812, where the number of instructions 1810 and the number of registers 1812 may be associated with static code generation (i.e., “codegen”) for ray traversal shaders. A register may refer to a circuit that is able to read and write bit(s) at a time and use an address to select a particular register in a manner similar to a memory address. The number of instructions 1810 may correspond to an instruction size, where the instruction size may be an average number of instructions executed by each thread associated with a ray traversal. The number of registers 1812 may correspond to “register pressure,” where the “register pressure” may correspond to an average number of registers used by each thread.

At 1814, the device may use the static features to create a decision tree. The decision tree may be used to tune compiler heuristics for unrolling a loop associated with a BVH traversal. As used herein, a decision tree may refer to instructions to perform different actions based on certain conditions being met. At 1816, the device may use the tuned compiler heuristics for unrolling the loop associated with the BVH traversal during a compilation with a new application.

The above-described technologies may be used in a BVH traversal (e.g., a BVH tree traversal) in a ray query and ray pipeline workload. The above-described technologies may optimize codegen for ray traversal in acceleration structures. The above-described technologies may be implemented on a chipset that has a suitable instruction cache size to utilize benefits of loop unrolling.

The above-described technologies may be associated with various advantages. For example, unrolling a loop may aid in optimizing codegen by using compiler optimizations on an unrolled loop and a lesser amount of jump instructions (e.g., back edges). Some other approaches for codegen may not be able to determine a loop count and/or geometry at a compile time and hence may not be able to unroll a loop. However, PGO may be able to facilitate unrolling a loop based on previous runs and hence may improve performance. For example, unrolling a loop via PGO as described above may improve an execution time of shaders and an overall frame rate of an application compared to approaches that do not unroll a loop via PGO. Furthermore, improved codegen provided via PGO may also improve a power efficiency of a shader compared to approaches that do not unroll a loop via PGO.

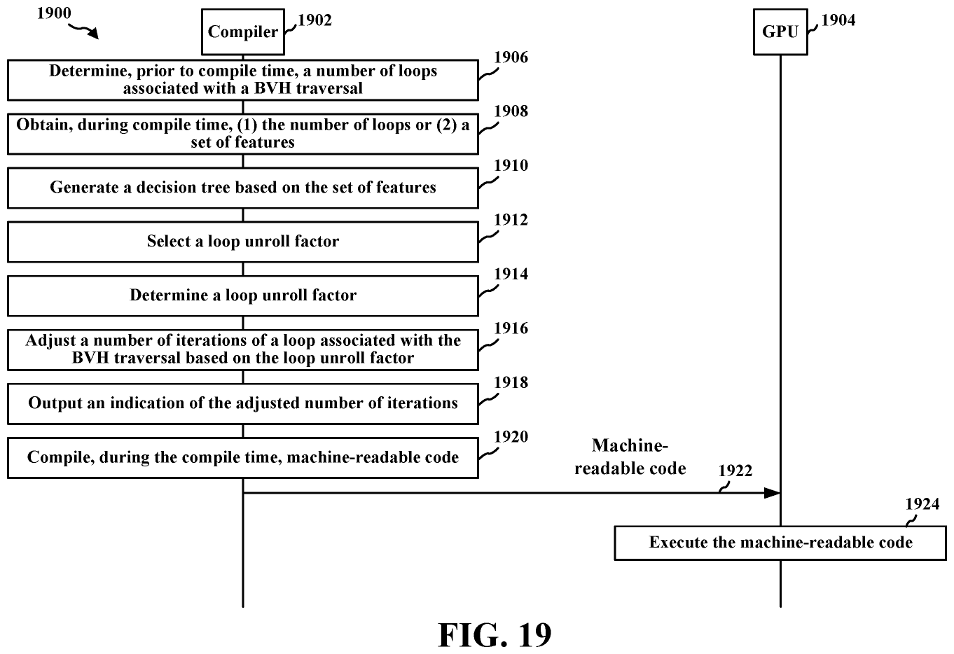

FIG. 19 is a call flow diagram 1900 illustrating example communications between a compiler 1902 and a GPU 1904 in accordance with one or more techniques of this disclosure. In an example, the compiler 1902 and the GPU 1904 may be included in the device 104.

At 1908, the compiler 1902 may obtain, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader. At 1914, the compiler 1902 may determine, during the compile time, a loop unroll factor based on at least one of the obtained number of loops or the obtained set of features. At 1916, the compiler 1902 may adjust, during the compile time, a number of iterations of a loop associated with the BVH traversal based on the loop unroll factor. At 1918, the compiler 1902 may output an indication of the adjusted number of iterations.

In one aspect, at 1906, the compiler 1902 may determine, prior to the compile time, the number of loops associated with the BVH traversal based the number of ray triangle intersections and the number of ray box intersections, where the obtainment of at least one of the number of loops associated with the BVH traversal and the number of ray box intersections may be based on the determination. In one aspect, at 1910, the compiler 1902 may generate a decision tree based on the set of features, where determining the loop unroll factor at 1914 may include determining the loop unroll factor further based on the generated decision tree. In one aspect, the BVH traversal may be associated with a frame that includes a plurality of geometries, where determining the loop unroll factor based on at least one of the obtained number of loops or the set of features at 1914 may include determining a plurality of loop unroll factors for the plurality of geometries based on at least one of the obtained number of loops or the set of features, and at 1912, the compiler 1902 may select the loop unroll factor from amongst the plurality of loop unroll factors based on the loop unroll factor being a minimum loop unroll factor in the plurality of loop unroll factors. In one aspect, at 1920, the compiler 1902 may compile, during the compile time, machine-readable code, where the machine-readable code may be based on the number of iterations of the loop. As used herein, machine-readable code may refer to code that is able to be executed by processor(s). In one aspect, at 1922, the compiler 1902 may provide the machine-readable code to the GPU 1904. At 1924, the GPU 1904 may execute the machine-readable code. Executing the machine-readable code may be part of a ray tracing process. For instance, executing the machine-readable code may cause the GPU to perform a BVH traversal as part of the ray tracing process.

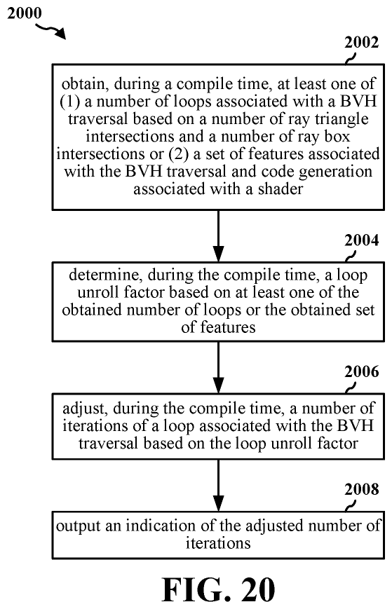

FIG. 20 is a flowchart 2000 of an example method of graphics processing in accordance with one or more techniques of this disclosure. The method may be performed by an apparatus, such as an apparatus for graphics processing, a GPU, a CPU, a compiler (e.g., the compiler 1902), the device 104, a wireless communication device, and the like, as used in connection with the aspects of FIGS. 1-3, FIG. 4A, FIG. 4B, FIG. 5, FIG. 6A, FIG. 6B, FIG. 7A, FIG. 7B, FIG. 8A, FIG. 8B, FIGS. 9-12, FIG. 13A, FIG. 13B, FIGS. 14-15, FIG. 16A, FIG. 16B, and FIGS. 17-19. The method may be associated with various advantages, such as unrolling a loop associated with ray tracing at compile time, which may improve performance. In an example, the method may be performed by the loop unroller 198.

At 2002, the apparatus obtains, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader. For example, FIG. 19 at 1908 shows that the compiler 1902 may obtain, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader. In an example, the BVH traversal may be associated with the BVH illustrated in FIG. 6A and FIG. 6B. In another example, the BVH traversal may include a traversal of the binary bounding volume hierarchy 710 or the wide bounding volume hierarchy 760. In another example, the BVH traversal may correspond to the example 1202. In an example, obtaining the number of loops may correspond to 1708 in FIG. 17. In an example, the number of ray triangle intersections and the number of ray box intersections may be associated with equation (I) above. In another example, the set of features associated with the BVH traversal may include the static features 1806, and the code generation may be based on the static features 1806. In an example, the shader may be a shader in the ray tracing pipeline 1402. In an example, 2002 may be performed by the loop unroller 198.

At 2004, the apparatus determines, during the compile time, a loop unroll factor based on at least one of the obtained number of loops or the obtained set of features. For example, FIG. 19 at 1914 shows that the compiler 1902 may determine, during the compile time, a loop unroll factor based on at least one of the obtained number of loops or the obtained set of features. In an example, the loop unroll factor may correspond to 1712 and/or 1716. In an example, 2004 may be performed by the loop unroller 198.

At 2006, the apparatus adjusts, during the compile time, a number of iterations of a loop associated with the BVH traversal based on the loop unroll factor. For example, FIG. 19 at 1916 shows that the compiler 1902 may adjust, during the compile time, a number of iterations of a loop associated with the BVH traversal based on the loop unroll factor. In an example, adjusting the number of iterations of the loop may include reducing a number of iterations of the loop. In an example, 2006 may be performed by the loop unroller 198.

At 2008, the apparatus outputs an indication of the adjusted number of iterations. For example, FIG. 19 at 1918 shows that the compiler 1902 may output an indication of the adjusted number of iterations. In an example, 2008 may be performed by the loop unroller 198.

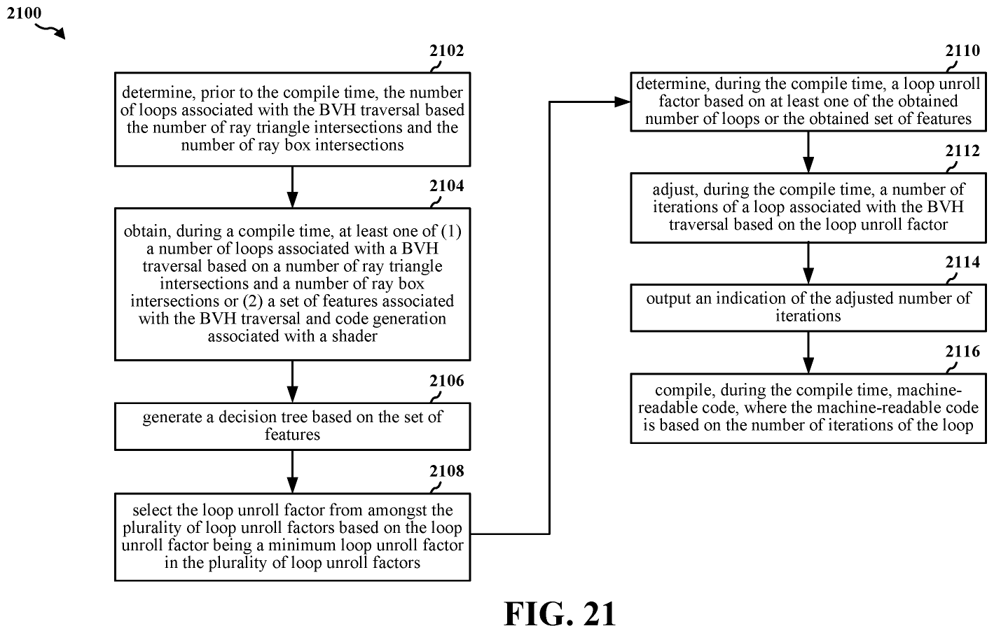

FIG. 21 is a flowchart 2100 of an example method of graphics processing in accordance with one or more techniques of this disclosure. The method may be performed by an apparatus, such as an apparatus for graphics processing, a GPU, a CPU, a compiler (e.g., the compiler 1902), the device 104, a wireless communication device, and the like, as used in connection with the aspects of FIGS. 1-3, FIG. 4A, FIG. 4B, FIG. 5, FIG. 6A, FIG. 6B, FIG. 7A, FIG. 7B, FIG. 8A, FIG. 8B, FIGS. 9-12, FIG. 13A, FIG. 13B, FIGS. 14-15, FIG. 16A, FIG. 16B, and FIGS. 17-19. The method may be associated with various advantages, such as unrolling a loop associated with ray tracing at compile time, which may improve performance. In an example, the method (including the various aspects detailed below) may be performed by the loop unroller 198.

At 2104, the apparatus obtains, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader. For example, FIG. 19 at 1908 shows that the compiler 1902 may obtain, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader. In an example, the BVH traversal may be associated with the BVH illustrated in FIG. 6A and FIG. 6B. In another example, the BVH traversal may include a traversal of the binary bounding volume hierarchy 710 or the wide bounding volume hierarchy 760. In another example, the BVH traversal may correspond to the example 1202. In an example, obtaining the number of loops may correspond to 1708 in FIG. 17. In an example, the number of ray triangle intersections and the number of ray box intersections may be associated with equation (I) above. In another example, the set of features associated with the BVH traversal may include the static features 1806, and the code generation may be based on the static features 1806. In an example, the shader may be a shader in the ray tracing pipeline 1402. In an example, 2104 may be performed by the loop unroller 198.

At 2110, the apparatus determines, during the compile time, a loop unroll factor based on at least one of the obtained number of loops or the obtained set of features. For example, FIG. 19 at 1914 shows that the compiler 1902 may determine, during the compile time, a loop unroll factor based on at least one of the obtained number of loops or the obtained set of features. In an example, the loop unroll factor may correspond to 1712 and/or 1716. In an example, 2110 may be performed by the loop unroller 198.

At 2112, the apparatus adjusts, during the compile time, a number of iterations of a loop associated with the BVH traversal based on the loop unroll factor. For example, FIG. 19 at 1916 shows that the compiler 1902 may adjust, during the compile time, a number of iterations of a loop associated with the BVH traversal based on the loop unroll factor. In an example, adjusting the number of iterations of the loop may include reducing a number of iterations of the loop. In an example, 2112 may be performed by the loop unroller 198.

At 2114, the apparatus outputs an indication of the adjusted number of iterations. For example, FIG. 19 at 1918 shows that the compiler 1902 may output an indication of the adjusted number of iterations. In an example, 2114 may be performed by the loop unroller 198.

In one aspect, adjusting the number of iterations of the loop based on the loop unroll factor may include unrolling the loop based on the loop unroll factor. For example, adjusting the number of iterations of the loop based on the loop unroll factor at 1916 may include unrolling the loop based on the loop unroll factor

In one aspect, the set of features may include at least one of a depth of a BVH tree associated with an application, a number of instructions executed by a thread associated with the application, or a number of registers used by the thread. For example, the depth of the BVH tree may be or include the depth of the BVH tree 1808, the number of instructions may be the number of instructions 1810, and the number of registers may be the number of registers 1812.

In one aspect, the depth of the BVH tree may include an average depth of a plurality of BVH trees associated with a plurality of geometries of the application, where the number of instructions executed by the thread may include an average number of instructions executed by the thread for the plurality of geometries, and where the number of registers used by the thread may include an average number of registers used by the thread for the plurality of geometries. For example, the depth of the BVH tree 1808 may be an average depth of a plurality of BVH trees associated with a plurality of geometries of the application, the number of instructions may be an average number of instructions executed by the thread for the plurality of geometries, and the number of registers 1812 may be an average number of registers used by the thread for the plurality of geometries.

In one aspect, at 2102, the apparatus may determine, prior to the compile time, the number of loops associated with the BVH traversal based the number of ray triangle intersections and the number of ray box intersections, where the obtainment of at least one of the number of loops associated with the BVH traversal and the number of ray box intersections may be based on the determination. For example, FIG. 19 at 1906 shows that the compiler 1902 may determine, prior to the compile time, the number of loops associated with the BVH traversal based the number of ray triangle intersections, the number of ray box intersections, and the number of threads associated with the BVH traversal, where the obtainment of at least one of the number of loops associated with the BVH traversal, the number of ray box intersections, and the number of threads may be based on the determination. In an example, 2102 may be performed by the loop unroller 198.

In one aspect, the number of loops associated with the BVH traversal may be for a first frame, where the loop may be associated with a second frame, and where the first frame may be prior to the second frame. For example, the number of loops associated with the BVH traversal at 1908 may be for a first frame, where the loop may be associated with a second frame, and where the first frame may be prior to the second frame.

In one aspect, determining the number of loops associated with the BVH traversal may include determining the number of loops by way of a profile guided optimization (PGO) process for the first frame. For example, the aforementioned aspect may correspond to the PGO based loop unrolling 1702.

In one aspect, determining the number of loops associated with the BVH traversal based on the number of ray triangle intersections and the number of ray box intersections may include: computing a sum of the number of ray triangle intersections and the number of ray box intersections; and dividing the sum by a number of threads associated with the BVH traversal. For example, the aforementioned aspect may correspond to equation (I) above.

In one aspect, obtaining the number of loops may include obtaining the number of loops based on a hardware counter. For example, the aforementioned aspect may correspond to 1706 in FIG. 17.

In one aspect, the compile time may be associated with a just-in-time (JIT) compiler. For example, the compiler 1902 may be a JIT compiler, and the compile time may be associated with the JIT compiler. As used herein, a JIT compiler may refer to a compiler that compiles code at run time rather than at execution. For instance, a JIT compiler may perform a compilation when a driver requests that a program be compiled.

In one aspect, at 2106, the apparatus may generate a decision tree based on the set of features, where determining the loop unroll factor may include determining the loop unroll factor further based on the generated decision tree. For example, FIG. 19 at 1910 shows that the compiler 1902 may generate a decision tree based on the set of features, where determining the loop unroll factor at 1914 may include determining the loop unroll factor further based on the generated decision tree. In an example, the aforementioned aspect may correspond to 1814. In an example, 2106 may be performed by the loop unroller 198.

In one aspect, the BVH traversal may be associated with a frame that includes a plurality of geometries, where determining the loop unroll factor based on at least one of the obtained number of loops or the set of features may include determining a plurality of loop unroll factors for the plurality of geometries based on at least one of the obtained number of loops or the set of features, and at 2108, the apparatus may select the loop unroll factor from amongst the plurality of loop unroll factors based on the loop unroll factor being a minimum loop unroll factor in the plurality of loop unroll factors. For example, the BVH traversal in 1908 may be associated with a frame that includes a plurality of geometries, where determining the loop unroll factor based on at least one of the obtained number of loops or the set of features may include determining a plurality of loop unroll factors for the plurality of geometries based on at least one of the obtained number of loops or the set of features, and FIG. 19 at 1912 shows that the compiler 1902 may select the loop unroll factor from amongst the plurality of loop unroll factors based on the loop unroll factor being a minimum loop unroll factor in the plurality of loop unroll factors. In an example, the plurality of geometries may be associated with the example 1302. In an example, the aforementioned aspect may correspond to 1716 in FIG. 17. In an example, 2108 may be performed by the loop unroller 198.

In one aspect, the BVH traversal may be associated with a ray tracing process. For example, the BVH traversal may be associated with the ray tracing process described above in connection with FIG. 3, FIG. 4B, or FIG. 10. In another example, the ray tracing process may be associated with the ray tracing pipeline 1402.

In one aspect, at 2116, the apparatus may compile, during the compile time, machine-readable code, where the machine-readable code may be based on the number of iterations of the loop. For example, FIG. 19 at 1920 shows that the compiler 1902 may compile, during the compile time, machine-readable code, where the machine-readable code may be based on the number of iterations of the loop. In an example, the aforementioned aspect may correspond to 1716 or 1816. In an example, 2116 may be performed by the loop unroller 198.

In one aspect, determining the loop unroll factor based on at least one of the obtained number of loops or the set of features may include estimating the loop unroll factor based on at least one of the obtained number of loops or the set of features. For example, determining the loop unroll factor based on at least one of the obtained number of loops or the set of features at 1914 may include estimating the loop unroll factor based on at least one of the obtained number of loops or the set of features. In an example, the aforementioned aspect may correspond to 1712.

In one aspect, outputting the indication of the adjusted number of iterations may include: storing, in at least one of a memory, a buffer, or a cache, the indication of the adjusted number of iterations; or transmitting, for a next invocation of a compiler, the indication of the adjusted number of iterations. For example, outputting the indication of the adjusted number of iterations at 1918 may include: storing, in at least one of a memory, a buffer, or a cache, the indication of the adjusted number of iterations; or transmitting, for a next invocation of a compiler, the indication of the adjusted number of iterations.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader. The apparatus may further include means for determining, during the compile time, a loop unroll factor based on at least one of the obtained number of loops or the obtained set of features. The apparatus may further include means for adjusting, during the compile time, a number of iterations of a loop associated with the BVH traversal based on the loop unroll factor. The apparatus may further include means for outputting an indication of the adjusted number of iterations. The apparatus may further include means for determining, prior to the compile time, the number of loops associated with the BVH traversal based the number of ray triangle intersections and the number of ray box intersections, where the obtainment of at least one of the number of loops associated with the BVH traversal and the number of ray box intersections is based on the determination. The apparatus may further include means for generating a decision tree based on the set of features, where determining the loop unroll factor includes determining the loop unroll factor further based on the generated decision tree. The apparatus may further include means for selecting the loop unroll factor from amongst the plurality of loop unroll factors based on the loop unroll factor being a minimum loop unroll factor in the plurality of loop unroll factors. The apparatus may further include means for compiling, during the compile time, machine-readable code, where the machine-readable code is based on the number of iterations of the loop.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, including: obtaining, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader; determining, during the compile time, a loop unroll factor based on at least one of the obtained number of loops or the obtained set of features; adjusting, during the compile time, a number of iterations of a loop associated with the BVH traversal based on the loop unroll factor; and outputting an indication of the adjusted number of iterations.

Aspect 2 may be combined with aspect 1, wherein adjusting the number of iterations of the loop based on the loop unroll factor includes unrolling the loop based on the loop unroll factor.

Aspect 3 may be combined with any of aspects 1-2, wherein the set of features includes at least one of a depth of a BVH tree associated with an application, a number of instructions executed by a thread associated with the application, or a number of registers used by the thread.

Aspect 4 may be combined with aspect 3, wherein the depth of the BVH tree includes an average depth of a plurality of BVH trees associated with a plurality of geometries of the application, wherein the number of instructions executed by the thread includes an average number of instructions executed by the thread for the plurality of geometries, and wherein the number of registers used by the thread includes an average number of registers used by the thread for the plurality of geometries.

Aspect 5 may be combined with any of aspects 1-4, further including: determining, prior to the compile time, the number of loops associated with the BVH traversal based the number of ray triangle intersections and the number of ray box intersections, wherein the obtainment of at least one of the number of loops associated with the BVH traversal and the number of ray box intersections is based on the determination.

Aspect 6 may be combined with aspect 5, wherein the number of loops associated with the BVH traversal is for a first frame, wherein the loop is associated with a second frame, and wherein the first frame is prior to the second frame.

Aspect 7 may be combined with aspect 6, wherein determining the number of loops associated with the BVH traversal includes determining the number of loops by way of a profile guided optimization (PGO) process for the first frame.

Aspect 8 may be combined with any of aspects 5-7, wherein determining the number of loops associated with the BVH traversal based on the number of ray triangle intersections and the number of ray box intersections includes: computing a sum of the number of ray triangle intersections and the number of ray box intersections; and dividing the sum by a number of threads associated with the BVH traversal.

Aspect 9 may be combined with any of aspects 1-8, wherein obtaining the number of loops includes obtaining the number of loops based on a hardware counter.

Aspect 10 may be combined with any of aspects 1-9, wherein the compile time is associated with a just-in-time (JIT) compiler.

Aspect 11 may be combined with any of aspects 1-10, further including: generating a decision tree based on the set of features, wherein determining the loop unroll factor includes determining the loop unroll factor further based on the generated decision tree.

Aspect 12 may be combined with any of aspects 1-11, wherein the BVH traversal is associated with a frame that includes a plurality of geometries, wherein determining the loop unroll factor based on at least one of the obtained number of loops or the set of features includes determining a plurality of loop unroll factors for the plurality of geometries based on at least one of the obtained number of loops or the set of features, the method further including: selecting the loop unroll factor from amongst the plurality of loop unroll factors based on the loop unroll factor being a minimum loop unroll factor in the plurality of loop unroll factors.

Aspect 13 may be combined with any of aspects 1-12, wherein the BVH traversal is associated with a ray tracing process.

Aspect 14 may be combined with any of aspects 1-13, further including: compiling, during the compile time, machine-readable code, wherein the machine-readable code is based on the number of iterations of the loop.

Aspect 15 may be combined with any of aspects 1-14, wherein determining the loop unroll factor based on at least one of the obtained number of loops or the set of features includes estimating the loop unroll factor based on at least one of the obtained number of loops or the set of features.

Aspect 16 may be combined with any of aspects 1-15, wherein outputting the indication of the adjusted number of iterations includes: storing, in at least one of a memory, a buffer, or a cache, the indication of the adjusted number of iterations; or transmitting the indication of the adjusted number of iterations.

Aspect 17 is an apparatus for graphics processing including a memory and a processor coupled to the memory and, based on information stored in the memory, the processor is configured to implement a method as in any of aspects 1-15.

Aspect 18 may be combined with aspect 17 and includes that the apparatus is a wireless communication device comprising at least one of a transceiver or an antenna coupled to the processor.

Aspect 19 is an apparatus for graphics processing including means for implementing a method as in any of aspects 1-15.

Aspect 20 is a computer-readable medium storing computer executable code, the computer executable code, when executed by a processor, causes the processor to implement a method as in any of aspects 1-15.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
obtain, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader;
determine, during the compile time, a loop unroll factor based on at least one of the obtained number of loops or the obtained set of features;
adjust, during the compile time, a number of iterations of a loop associated with the BVH traversal based on the loop unroll factor; and
output an indication of the adjusted number of iterations.

2. The apparatus of claim 1, wherein to adjust the number of iterations of the loop based on the loop unroll factor, the processor is configured to unroll the loop based on the loop unroll factor.

3. The apparatus of claim 1, wherein the set of features comprises at least one of a depth of a BVH tree associated with an application, a number of instructions executed by a thread associated with the application, or a number of registers used by the thread.

4. The apparatus of claim 3, wherein the depth of the BVH tree comprises an average depth of a plurality of BVH trees associated with a plurality of geometries of the application, wherein the number of instructions executed by the thread comprises an average number of instructions executed by the thread for the plurality of geometries, and wherein the number of registers used by the thread comprises an average number of registers used by the thread for the plurality of geometries.

5. The apparatus of claim 1, wherein the processor is further configured to:
determine, prior to the compile time, the number of loops associated with the BVH traversal based the number of ray triangle intersections and the number of ray box intersections, wherein the obtainment of at least one of the number of loops associated with the BVH traversal and the number of ray box intersections is based on the determination.

6. The apparatus of claim 5, wherein the number of loops associated with the BVH traversal is for a first frame, wherein the loop is associated with a second frame, and wherein the first frame is prior to the second frame.

7. The apparatus of claim 6, wherein to determine the number of loops associated with the BVH traversal, the processor is configured to determine the number of loops by way of a profile guided optimization (PGO) process for the first frame.

8. The apparatus of claim 5, wherein to determine the number of loops associated with the BVH traversal based on the number of ray triangle intersections and the number of ray box intersections, the processor is configured to:
compute a sum of the number of ray triangle intersections and the number of ray box intersections; and
divide the sum by a number of threads associated with the BVH traversal.

9. The apparatus of claim 1, wherein to obtain the number of loops, the processor is configured to obtain the number of loops based on a hardware counter.

10. The apparatus of claim 1, wherein the compile time is associated with a just-in-time (JIT) compiler.

11. The apparatus of claim 1, wherein the processor is further configured to:
generate a decision tree based on the set of features, wherein to determine the loop unroll factor, the processor is configured to determine the loop unroll factor further based on the generated decision tree.

12. The apparatus of claim 1, wherein the BVH traversal is associated with a frame that includes a plurality of geometries, wherein to determine the loop unroll factor based on at least one of the obtained number of loops or the set of features, the processor is configured to determine a plurality of loop unroll factors for the plurality of geometries based on at least one of the obtained number of loops or the set of features, and wherein the processor is further configured to:
select the loop unroll factor from amongst the plurality of loop unroll factors based on the loop unroll factor being a minimum loop unroll factor in the plurality of loop unroll factors.

13. The apparatus of claim 1, wherein the BVH traversal is associated with a ray tracing process.

14. The apparatus of claim 1, wherein the processor is further configured to:
compile, during the compile time, machine-readable code, wherein the machine-readable code is based on the number of iterations of the loop.

15. The apparatus of claim 1, wherein to determine the loop unroll factor based on at least one of the obtained number of loops or the set of features, the processor is configured to estimate the loop unroll factor based on at least one of the obtained number of loops or the set of features.

16. The apparatus of claim 1, wherein to output the indication of the adjusted number of iterations, the processor is configured to:
store, in at least one of the memory, a buffer, or a cache, the indication of the adjusted number of iterations; or
transmit, for a next invocation of a compiler, the indication of the adjusted number of iterations.

17. The apparatus of claim 1, wherein the apparatus is a wireless communication device comprising at least one of a transceiver or an antenna coupled to the processor.

18. A method of graphics processing, comprising:
obtaining, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader;
determining, during the compile time, a loop unroll factor based on at least one of the obtained number of loops or the obtained set of features;
adjusting, during the compile time, a number of iterations of a loop associated with the BVH traversal based on the loop unroll factor; and
outputting an indication of the adjusted number of iterations.

19. The method of claim 18, wherein adjusting the number of iterations of the loop based on the loop unroll factor comprises unrolling the loop based on the loop unroll factor.

20. A computer-readable medium storing computer executable code, the computer executable code, when executed a processor, causes the processor to:
obtain, during a compile time, at least one of (1) a number of loops associated with a bounding volume hierarchy (BVH) traversal based on a number of ray triangle intersections and a number of ray box intersections or (2) a set of features associated with the BVH traversal and code generation associated with a shader;
determine, during the compile time, a loop unroll factor based on at least one of the obtained number of loops or the obtained set of features;
adjust, during the compile time, a number of iterations of a loop associated with the BVH traversal based on the loop unroll factor; and
output an indication of the adjusted number of iterations.
